(19) United States
(12) Patent Application Publication
(10) Pub. No.: US 2022/0369655 A1
(43) Pub. Date: Nov. 24, 2022

(54) APPARATUS FOR INTRODUCING DRY ICE PELLETS INTO FRESH MEAT

(71) Applicants: Messer Group GmbH, Bad Soden (DE); Dam Tech bvba, Bissegem (BE)

(72) Inventors: David Mussly, Bissegem (BE); Jean-Claude Claeys, Zwijndrecht (BE)

(73) Assignees: Messer Group GmbH, Bad Soden (DE); Dam Tech bvba, Bissegem (BE)

(21) Appl. No.: 17/770,677

(22) PCT Filed: Oct. 22, 2020
(86) PCT No.: PCT/EP2020/079795

§ 371 Date: Apr. 21, 2022

(30) Foreign Application Priority Data
Oct. 25, 2019 (DE) 10 2019 007 438.6

(51) Int. Cl. A22C 17/00

(52) U.S. Cl. CPC A22C 17/0053

(57) ABSTRACT

An apparatus for introducing dry ice pellets into fresh meat comprises a housing, in which an injection device for introducing dry ice pellets is arranged, and guide channels, which lead to a front face of the housing, for guiding a penetration needle, and a drive device for axially moving the penetration needle. A loading unit can be inserted between a rear portion and a front portion of the housing, which loading unit is provided with feedthroughs, which can be equipped with dry ice pellets and brought into a position in alignment with the guide channels. During operation of the apparatus, penetration channels are first produced, by means of the penetration needles, in a piece of meat to be cooled, into which penetration channels the dry ice pellets are subsequently introduced from the feedthroughs using the penetration needles. The feedthrough enables efficient introduction of dry ice pellets into the meat.

### CROSS-REFERENCE TO RELATED APPLICATIONS

This application is the U.S. national stage application of International Application No. PCT/EP2020/079795, filed Oct. 22, 2020, which International Application was published on Apr. 29, 2021, as International Publication WO 2021/078883 A1 in the German language. The International Application claims priority to German Application No. 10 2019 007 438.6, filed Oct. 25, 2019. The International Application and German Application are hereby incorporated herein by reference, in their entireties.

### FIELD

The invention relates to a device for introducing dry ice pellets.

### BACKGROUND

The biochemical processes together with the structural changes post mortem in the meat of various slaughtered animals, and the associated changes in the quality of the meat, are described, for example, in the article by R. Binke: “Vom Muskel zum Fleisch” (“From muscle to meat”), Mitteilungsblatt BAFF 42, No. 162, p. 347 (2003).

The accumulation of the metabolic product lactate (salt of lactic acid) causes the muscle pH value to drop from pH 6.8 to 7.2 to pH 5.5 within a few hours. This process is also called acidification. The speed of this process and the final pH value are of great importance for the maturation process and storage life, and thus for the quality of the meat. Since these processes are temperature-dependent, the cooling process that takes place after slaughter also decisively influences the quality of the meat.

High temperatures in the meat result in biochemical reactions that proceed rapidly and can cause the pH value to drop too quickly to values below 5.6, and can consequently result in the development of undesirable “PSE meat”. On the other hand, excessively rapid cooling of the carcass to temperatures below 10° C. before the onset of rigor mortis is also disadvantageous, as it inhibits the acidification of the meat necessary for good meat quality and causes cold shortening in the muscle. The resulting “DFD meat” (in the case of pork) or “DCB meat” (in the case of beef) is characterized by a high pH value of over 6.2; it is tough and has a low juice retention capacity.

Furthermore, in particular in the case of larger pieces of meat, it is important that cooling takes place homogeneously throughout the entire volume of meat, as an uneven cooling rate results in uneven states of maturation and thus uneven meat qualities within the piece of meat. In the processing of ham, for example, this means that the meat deep inside in the immediate vicinity of the bone is often removed as inferior meat and excluded from further processing.

In the following, the term “fresh meat” shall mean meat in the treatment period between slaughter and completed meat maturation. Meat maturation comprises a series of biochemical reactions that take place in the muscle tissue after slaughter. Various naturally occurring enzymes in the meat bring about these processes and thus enhance the palatability of meat. The maturation process must take place under controlled conditions, in particular at a controlled temperature and controlled pH value.

In the following, “dry ice pellets” shall be understood as hard pieces of solid carbon dioxide that have been produced by compressing carbon dioxide snow or by freezing liquid carbon dioxide.

Known from EP 0 707 796 A1 and U.S. Pat. No. 5,413,526 B 1 are appliances by means of which a solid coolant, in particular dry ice, can be injected into pieces of meat. The appliances each comprise a slitting means used to form a pocket in the piece of meat to be cooled, into which a block of dry ice or a multiplicity of smaller dry ice pellets of solid carbon dioxide is subsequently filled by a filling means. A disadvantage of these items is that, as a result of a comparatively large amount of coolant being put into individual large pockets, very inhomogeneous cooling occurs, which in turn results in inhomogeneous meat quality. In addition, the dry ice pieces cannot always be held securely in the incisions made by the slitting means, which subsequently results in additional work and loss of coolant.

### SUMMARY

The invention is therefore based on the object of improving the process of maturation of fresh meat after slaughter in such a manner that a more homogeneous meat quality is achieved, in particular in the case of large-volume pieces of meat such as, for example, uncut hams, and the amount of work and cooling medium is reduced in comparison with known devices.

This object is achieved by a device having the features of claim 1. Advantageous embodiments of the invention are indicated in the subclaims.

According to the invention, a device for introducing dry ice pellets into fresh meat comprises a housing having with a rear section and a front section, located between which there a charging receiver for receiving a charging unit. Located in the housing there is an injection means or a plurality of injection means for introducing dry ice pellets. The injection means, or plurality of injection means, each comprise a guide channel in the rear section and in the front section of the housing, which are in mutual alignment. The front guide channel extending in the front section exits at a front side of the housing. Furthermore, the injection means comprises a piercing needle, which is pointed at its front, distal end and which is dimensioned in such a manner that it can be moved axially in the guide channels. The piercing needle is operatively connected to a drive means, by means of which the piercing needle can be moved between a working position and a rest position. In the working position, the piercing needle protrudes from the front side of the front section, as well as from all other parts of the housing; the pointed conformation of the distal end of the piercing needle allows the piercing needle, and only the piercing needle, to penetrate deeply into a piece of meat to be treated and there to leave a pierce channel, the inner diameter of which corresponds to the outer diameter of the piercing needle. In its rest position, the piercing needle is received in the rear guide channel in the rear section of the housing.

Furthermore, the device comprises a charging unit, which can be detachably connected to the housing and is equipped with at least one leadthrough that can be stocked with a dry ice pellet. When the charging unit has been fitted, this leadthrough, or at least one of the leadthroughs, is located between and in alignment with the guide channels in the rear section and front section; the guide channel in the rear section, the leadthrough and the guide channel in the front section of the housing thus together form a continuous channel in which the piercing needle can be moved axially. As the charging unit is being fitted into the charging receiver, the piercing needle of the at least one injection means is in its rest position in the rear section, i.e. behind a carbon dioxide pellet present in the leadthrough of the charging unit.

For the purpose of treating a piece of meat, for example a ham, the device according to the invention is placed with the front side of the housing in front of the piece of meat to be treated. Initially, a charging unit is not yet fitted in the charging receiver or is located in the charging receiver in such a manner that empty leadthroughs, i.e. leadthroughs not stocked with a carbon dioxide pellet, are in alignment with the guide channels of an injection unit/injection units. Then the drive means of the injection means is actuated, or the drive means of the plurality of injection means are actuated, and the respective piercing needle advances from its rest position into its working position, i.e. out of the front mouth opening of the front guide channel. In front of the mouth opening, the piercing needle, or piercing needles, penetrates, or penetrate, the tissue of the piece of meat with their pointed distal ends, and realize the aforementioned pierce channels there. The piercing needle, or piercing needles, is, or are, then retracted into their rest position by the respective drive means. Then a charging unit is positioned in the charging receiver in such a manner that a leadthrough stocked with a carbon dioxide pellet is in alignment with the guide channels. The carbon dioxide pellet is now in front of the distal end of the piercing needle, which is in its rest position. After the drive means has, or have, been actuated again, the piercing needle drives the carbon dioxide pellet into the previously opened pierce channel in the piece of meat. The piercing needle is then returned to its rest position by the drive means, while the carbon dioxide pellet remains in the pierce channel and there consequently provides uniform cooling of the piece of meat.

In the case of the device according to the invention, the piercing needle thus has a double function, realizing the pierce channel in the fresh meat and subsequently inserting the dry ice pellet into the pierce channel. Since the inner diameter of the pierce channel substantially corresponds to the outer diameter of the dry ice pellet, following insertion the latter is generally located in a secure and firm manner in the tissue.

The movement of the piercing needle into the working position, or into the rest position, by the drive means is effected, for example, mechanically, for instance by means of spring forces, pneumatically, for instance by compressed air, or electrically, for instance by one or more electromagnets or by means of an electric motor. In the case of an electric motor, for example, a servomotor or a linear motor is used. The drive unit in this case is preferably equipped with means that enable a rotary motion, for example a rotary motion of the shaft of an electric motor, to be converted into a translational movement, such as, for example, a screw mechanism. For example, the drive means comprises a servomotor and a screw mechanism that is operatively connected to the latter and by means of which the piercing needles can be inserted very precisely into a designated region of the piece of meat to be treated, and withdrawn again through the thus resulting pierce channel. As an alternative or in addition to the aforementioned drive possibilities, the drive means may also comprise a linear motor for moving the piercing needles translationally.

The same or different operating principles may be used for advancing and retracting the piercing needle; for example, the piercing needle is brought into its working position by means of compressed air and back into its rest position by means of a resetting spring, or in both cases compressed air, an electric drive or spring means are used. In particular to facilitate thorough cleaning, the housing and piercing needles are preferably made of stainless steel.

The charging unit serves as an exchangeable magazine for dry ice pellets, and after emptying is removed from the charging receiver and replaced by a new charging unit, stocked with dry ice pellets, which is inserted into the charging receiver. To facilitate the insertion of the charging unit, suitable elements such as, for example guide rails and/or catches may be provided in the housing.

An expedient further development of the invention is characterized in that located in the housing there is a plurality of injection means, each having a rear guide channel and a front guide channel in alignment with the rear guide channel. The associated charging unit has at least a number of leadthroughs, corresponding to the number of guide channels in mutual alignment, which leadthroughs can be stocked with dry ice pellets and, when the charging unit has been fitted, extend between the guide channels in mutual alignment and are in turn in alignment with the latter. In the case of this design of the device according to the invention, a plurality of dry ice pellets can thus be introduced simultaneously into a piece of meat. The guide channels, or leadthroughs, in this case can extend very close to one another to enable a large number of pellets to be introduced into a small volume; for example, the guide channels, or leadthroughs, adjoin one another with their outer walls directly or at a distance of 0.5 mm to 2 mm. Or the guide channels and leadthroughs have a comparatively large distance of, for example, 1-3 cm from each other, in order to achieve large-volume cooling of the piece of meat with a single actuation of the device.

A particularly preferred design of the invention provides that a plurality of leadthroughs, which can be stocked with dry ice pellets and which are located at an equal radial distance from a longitudinal axis and at equal angular distances from one another, are provided in the charging unit. In the case of this design, a plurality of leadthroughs are accordingly also provided in the housing, which are located at an equal radial distance from a longitudinal axis that corresponds to the longitudinal axis of the fitted charging unit, and at equal angular distances from one another, so that the guide channels can be brought into a position of alignment with at least some of the leadthroughs.

The charging unit in this case is preferably received in the charging receiver so as to be rotatable about the longitudinal axis. As a result of the fitted charging unit being rotated, the individual leadthroughs or groups of leadthroughs can thus be brought in succession into a position of alignment with the guide channels, and dry ice pellets loaded therein can be applied in succession into the piece of meat. In this case, it is conceivable to provide in the housing only a single injection means, with the guide channels of which the leadthroughs of the charging unit are brought in succession into a position of alignment and the dry ice pellets in the charging unit are applied in succession, or to provide a plurality of injection means that enable a group of dry ice pellets to be applied simultaneously.

Preferably, the charging unit in this case is operatively connected to a turret mechanism, located in the housing or in the charging unit, which is realized in such a manner that the charging unit, following an actuation of the drive means in such a manner that the piercing needle, or piercing needles, is or retracted into its or their rest position, is automatically rotated from a first position, in which a first leadthrough or a first group of leadthroughs is in alignment with the guide channels of the housing, into a second position, in which a second leadthrough or a second group of leadthroughs is in alignment with the guide channels of the housing.

The charging unit inserted into the housing thus has two operating positions, which can be transitioned into each other by a limited rotation of the charging unit, and in each of which different leadthroughs or groups of leadthroughs are in alignment with the guide channels. In a preferred approach, a first group of leadthroughs is empty when the charging unit is inserted into the housing, but a second group of leadthroughs is stocked with dry ice pellets. In the first operating position, the piercing needles push through the empty leadthroughs of the charging unit and penetrate the piece of meat, forming pierce channels. After the piercing needles have been retracted into their rest position and the charging device has been rotated to the second operating position, there is now a leadthrough stocked with a carbon dioxide pellet in front of each of the piercing needles. When the piercing needles are advanced again, the dry ice pellets are thus driven onto and into the pierce channels by the piercing needles.

As an alternative or in addition to the rotatable arrangement of the fitted charging unit, a preferred design of the invention provides that the charging unit can be pushed laterally into a charging receiver of the housing and can be locked in the charging receiver. Preferably, the charging receiver may also be designed in such a manner that a plurality of charging units are located on the device, each of which is brought in succession by lateral displacement into a position (working position) in which their leadthroughs are in alignment with guide channels of the housing. The displacement of the charging units into their working position is in this case preferably effected automatically, for example by means of an electric drive that is actuated by an operator of the device by the pressing of a button.

In order, on the one hand, to achieve sufficient cooling of a piece of meat and, on the other hand, to enable manageable manual operation of the device, the dry ice pellets injected by means of the device according to the invention should each have a mass of between 5 g and 50 g, and a volume of between 3 cm³ and 30 cm³, with a diameter of between 5 mm and 15 mm. The total mass of carbon dioxide introduced simultaneously into the treated piece of meat during an injection is, for example, between 20 g and 250 g, preferably between 100 g and 150 g.

The diameter of the piercing needles corresponds to the diameter of the dry ice pellets, and their length is selected in such a manner that a pierce channel sufficient for the length of the dry ice pellets to be injected can be created in the piece of meat. Consequently, the guide channels and the leadthroughs of the charging unit also preferably are of a diameter that-to ensure good axial mobility-is slightly greater than the diameter of the dry ice pellets to be injected, or of the piercing needles, i.e. also approximately between 5 mm and 15 mm.

Preferably, a number of at least three injection means, particularly preferably between four and sixteen injection means are provided in the housing. The number of leadthroughs in the corresponding charging unit is at least as great as the number of injection units in the housing.

In an again advantageous further development of the invention, the device is realized as a hand-held appliance and is in particular provided with a handle and/or with a triggering mechanism that can be actuated manually, which allows an operator to carry the device and to trigger the propulsion means. In operation, the device is placed with its front side on a piece of meat to be treated and then an automatic triggering mechanism is actuated by the operator, which automatically pushes the piercing needles into the piece of meat, creating pierce channels in the tissue of the piece of meat. The dry ice pellets are then injected without the need for a separate triggering by the operator.

The device according to the invention is suitable for cooling various types of meat, in particular beef and pork. A preferred application is the treatment of ham (leg or shoulder of pork), and in particular in the region of a bone, enables uniform cooling around the bone.

The invention makes it possible, in particular, to achieve a rapid cooling rate in the entire volume of the meat, even in a large piece of meat that has not been cut or boned, thereby achieving a uniformly high meat quality. Preferably, the entire volume of the piece of meat is cooled uniformly by a temperature difference of from 25 to 40° C. within a period of 30 min to 120 min.

### BRIEF DESCRIPTION OF THE DRAWINGS

The invention is now to be explained in greater detail on the basis of the drawing, in which, in schematic views:

FIGS. 1-3 show a device according to the invention, represented in part in longitudinal section, during different treatment phases,

FIG. 4 shows a charging unit for the device from FIG. 1, in a front view,

FIG. 5 shows the charging unit of another device according to the invention, in a front view.

### DETAILED DESCRIPTION

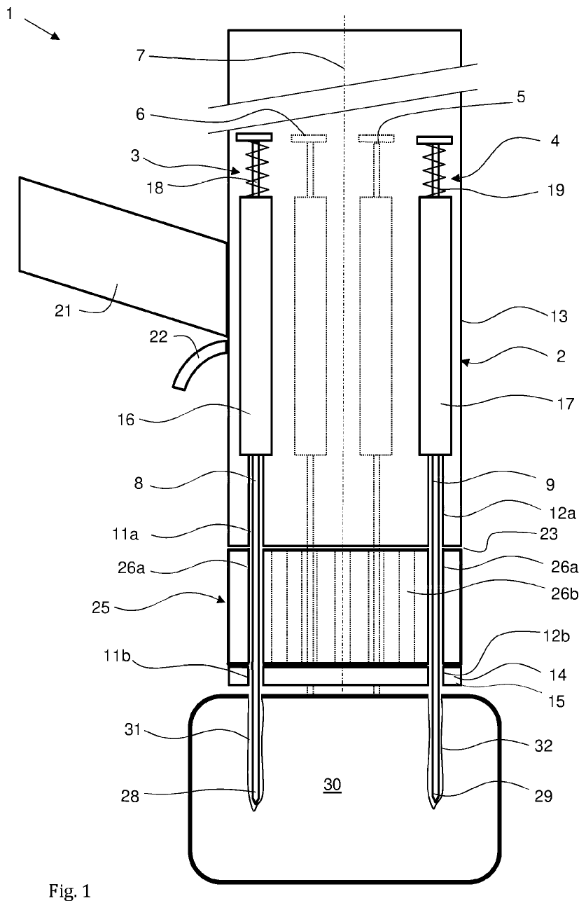

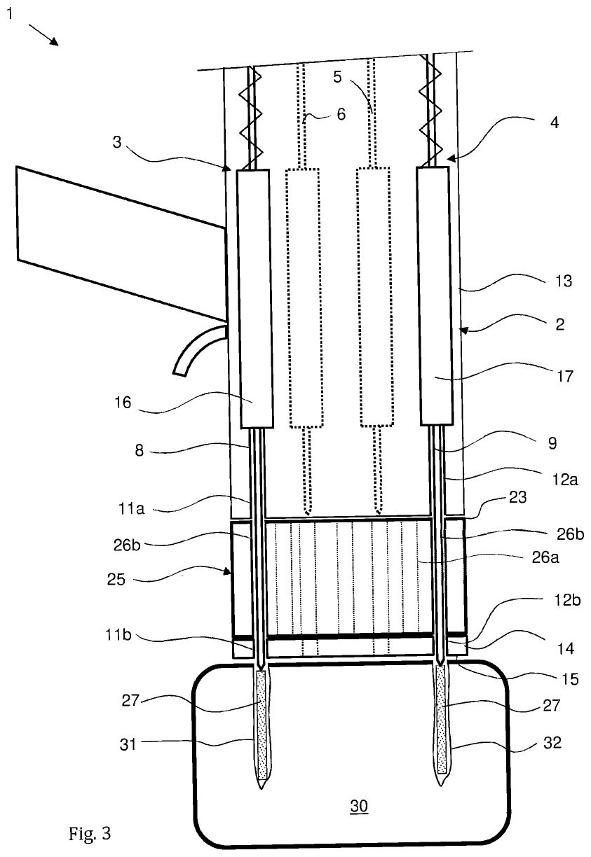

The device 1 represented in part in FIGS. 1-3 comprises a housing 2, within which a number of injection means 3, 4, 5, 6 are received. In the exemplary embodiment shown here, there are a total of six injection means within the housing 2, of which, however, only the injection means 3, 4 are shown in more detail here for reasons of clarity. and the injection means 5, 6 are merely indicated, because they are outside the sectional plane. Two further injection means are not shown, but are nevertheless present.

The injection means 3, 4, 5, 6 are each of the same design and are located inside the housing 2 at equal angular distances and at equal radial distance from a longitudinal axis 7 of the housing 2. Each of the injection means 3, 4, 5, 6 comprises a piercing needle 8, 9, each of which is received in an axially movable manner in two guide channels 11a, 11b; 12a, 12b in mutual alignment within the housing 2, the guide channels 11a, 12a extending in a rear section 13 and the guide channels 11b, 12b extending in a front section 14 of the housing. The guide channels 11b, 12b extending in the front section 14 exit the housing 2 at a front side 15 thereof.

Typically, the guide channels 11a, 11b; 12a, 12b have an inner diameter of between 5 mm and 15 mm; the outer diameter of the piercing needles 8, 9 is slightly smaller and is selected in such a manner that it is possible for the piercing needles 8, 9 to slide frictionlessly in the axial direction within the guide channels 11a, 11; 12a, 12b.

The piercing needles 8, 9 are each operatively connected to a drive means, which is received in the rear section 13 of the housing 2. The drive means each comprises a propulsion means 16, 17 and a return means 18, 19. The propulsion means 16, 17 are means operated, for example, pneumatically, e.g. by means of compressed air, or electromagnetically, by means of which the piercing needles 8, 9 are pushed to a limited extent, in axial direction, out of the mouth openings of the guide channels 11b, 12b located on the front side 15. In the exemplary embodiment, the return means 18, 19 are spring means by means of which the piercing needles 8, 9 are automatically retracted into the guide channels 11a, 12a after having been pushed to a limited extent out of the mouth openings of the guide channels 11b, 12b. However, pneumatic or electromagnetic means may also be used in the return means 18, 19; it is also conceivable to use an electric motor, such as a servomotor, which, by means of a suitable transmission, for instance a screw mechanism, both pushes the needles 8, 9 out of the guide channels 11b, 12b and automatically returns them into the guide channels 11a, 12a.

Furthermore, in the exemplary embodiment shown here, the device 1 is realized as a hand-held appliance that can be held by an operator, at a handle 21, and manually operated by the operator, at a trigger 22.

A charging unit 25 is located between the rear section 13 and the front section 14 of the housing 2, in a charging receiver 23 connecting the two sections 13, 14. In the exemplary embodiment shown in FIGS. 1-4, the charging unit 25 is a circular-cylindrical component that is detachably connected to the charging receiver 23 of the housing 2 and is supported so as to be rotatable about a longitudinal axis, which in the exemplary embodiment shown here corresponds to the longitudinal axis 7 of the housing. The charging unit 25 has a number of leadthroughs 26a, 26b located at equal angular distances, which extend through the charging unit 25 along its entire length. The inner diameter of the leadthroughs 26a, 26b and their radial distance from the longitudinal axis 7 correspond to the inner diameter and the radial distance, respectively, of the guide channels 11a, 11b; 12a, 12b. In the exemplary embodiment shown here, the number of leadthroughs 26a, 26b is a multiple of the number of pairs of guide channels 11a, 11b; 12a, 12b, for example twelve. However, the same number of leadthroughs 26a, 26b as pairs of guide channels 11a, 12a, or 11b, 12b, may also be provided. By means of a turret mechanism, not shown here, the charging unit 25 can be moved from a first position, in which a first group of leadthroughs 26a is in alignment with the guide channels 11a, 11b; 12a, 12b, into a second position, in which a second group of leadthroughs 26b is in alignment with the guide channels 11a, 11b; 12a, 12b.

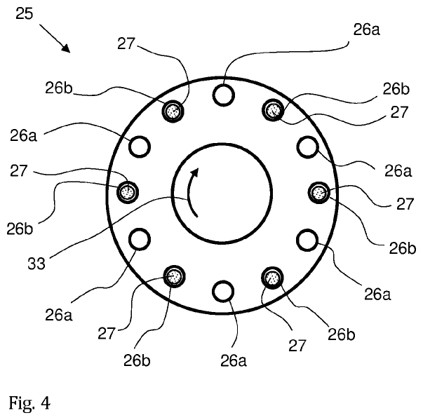

When the device 1 is in use, a charging unit 25 is first loaded with dry ice pellets 27, with only every second leadthrough (26b) being stocked with one carbon dioxide pellet 27 in each case, while the rest of the leadthroughs (26a) remain empty, as shown in FIG. 4. The length and the diameter of the dry ice pellets 27 is matched to the length and inner diameter of the leadthroughs 26a, 26b, for example, the length of the pellets (and thus of the charging unit 25) is between 5 cm and 10 cm, and their diameter between 4.9 mm and 14.9 mm. The injection means 3, 4, 5, 6 are brought into an operating position in which the piercing needles 8, 9 are retracted in the guide channels 11a, 12a in the rear section 13 of the housing 2. The charging unit 25 is then inserted into the housing 2, in such a manner that the leadthroughs 26a that are not stocked with carbon dioxide pellets 27 are in alignment with the guide channels 11a, 11b; 12a, 12b.

Actuation of the propulsion means 16, 17 causes the piercing needles 8, 9 to be pushed through the leadthroughs 26a and the guide channels 11b, 12b. The piercing needles 8, 9, pointed at their respective front ends 28, 29, push into a piece of meat 30, for example a ham, located in front of the front side 15 of the housing 2, where they form a ring of pierce channels 31, 32. For example, the pierce channels 31, 32 are made around a bone present in the piece of meat 30.

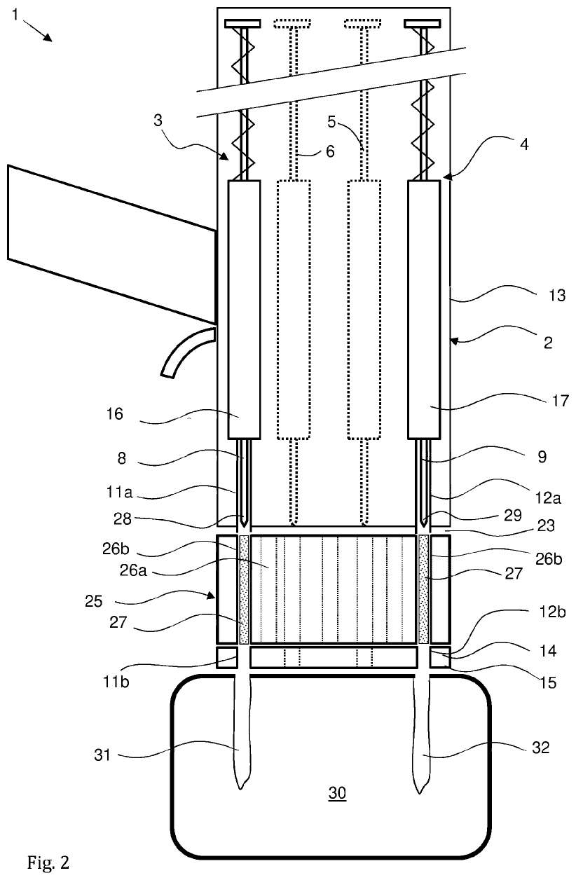

Following the formation of the pierce channels 31, 32, the piercing needles 8, 9 retract back into the guide channels 11a, 12a located in the rear section 13 of the housing under the action of the return means 18, 19. The charging unit 25 is then rotated about the longitudinal axis 7, in the direction of the arrow 33, until a new group of leadthroughs 26b is in alignment with the guide channels 11a, 11b; 12a, 12b. As these leadthroughs 26b are each stocked with a carbon dioxide pellet 27, there is now a carbon dioxide pellet 27 in front of each front end 28, 29 of each piercing needle 8, 9, as shown in FIG. 2.

Following the renewed-manually or automatically triggered-actuation of the propulsion means 16, 17, the piercing needles 8, 9 push the dry ice pellets 27 into the pierce channels 31, 32. The piercing needles 8, 9 are then returned to their previous position under the action of the return means 18, 19, while the dry ice pellets 27 remain in the pierce channels 31, 32. In this way, a plurality of dry ice pellets 27 are placed in large volume in the piece of meat 30, for example between the upper leg part and lower leg part of a ham, and as a result a uniform cooling of the piece of meat 30 is achieved.

The charging unit 25 is then removed from the housing 2, loaded with dry ice pellets 27, in a means not shown here, and then reinserted or replaced by another charging unit stocked with dry ice pellets.

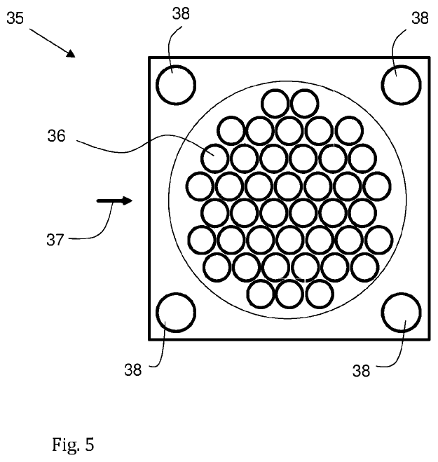

The charging unit 35 shown in FIG. 5 differs from the charging unit 25 in that the leadthroughs 36 that can be stocked with dry ice pellets, unlike the leadthroughs 27, are not rotationally symmetrical about an axis, but are arranged in mutually offset rows. Consequently, the charging unit 35 is also not supported in a rotationally symmetrical manner in the charging receiver of a device according to the invention—not shown here-but it is inserted laterally into the device, for example in the direction of the arrow 37. For this purpose, the charging unit 35 has fastening means, for example holes 38, at which the charging unit is fastened to a guide carriage, not shown here, by means of which the charging unit 35 can be inserted into the device. The associated device has a corresponding number of guide channels that, after the charging unit 35 has been inserted, are in alignment with its leadthroughs 36. With such a device it is possible, in particular, to introduce a large number of dry ice pellets 27 simultaneously and very close to each other into a piece of meat 30.

### LIST OF REFERENCES

1 device
2 housing
3 injection means
4 injection means
5 injection means
6 injection means
7 longitudinal axis
8 piercing needle
9 piercing needle
10-
11a, 11b guide channel
12a, 12b guide channel
13 rear section
14 front section
15 front side
16 propulsion means
17 propulsion means
18 return means
19 return means
20-
21 handle
22 trigger
23 charging receiver
24 charging unit
25-
26a, 26b leadthrough
27 dry ice pellets
28 front end
29 front end
30 piece of meat
31 pierce channel
32 pierce channel
33 arrow
34-
35 charging unit
36 leadthroughs
37 arrow
38 hole

1. A device for introducing dry ice pellets into fresh meat, comprising:
at least one injection means, which is received in a housing and has a rear guide channel extending longitudinally through a rear section of the housing and a front guide channel in alignment therewith that extends through a front section of the housing and exits at a front side of the housing, for guiding in an axially movable manner a piercing needle that is pointed at its distal end, and has a drive means for moving the piercing needle between a working position, in which it protrudes with its pointed distal end from the front side of the housing, and a rest position, in which it is received in the rear section of the housing; and
a charging unit, which has at least one leadthrough that can be stocked with dry ice pellets and that can be detachably inserted into a charging receiver located between the rear section and the front section of the housing in such a manner that the leadthrough is in alignment with the rear guide channel and the front guide channel.

2. The device as claimed in claim 1, wherein located in the housing is a plurality of injection means, each of which has a rear leadthrough and a front leadthrough in alignment therewith, and the charging unit is equipped at least with a number of leadthroughs, which can be stocked with dry ice pellets, corresponding to the number of guide channels in mutual alignment.

3. The device as claimed in claim 1, wherein a plurality of leadthroughs, which can be stocked with dry ice pellets and which are located at an equal radial distance from a longitudinal axis and at equal angular distances from one another, are provided in the charging unit.

4. The device as claimed in claim 3, wherein the charging unit, when having been fitted, is received in the housing so as to be rotatable about the longitudinal axis.

5. The device as claimed in claim 4, wherein the charging unit, when having been fitted, is operatively connected to a turret mechanism in the housing, which is realized in such a manner that the charging unit, following an actuation of the drive means in which the piercing needle of the injection means, or the piercing needles of the of a plurality of injection means, can be brought automatically from a first position, in which a first leadthrough or a first group of leadthroughs is in alignment with the guide channels in the housing, into a second position, in which a second leadthrough or a second group of leadthroughs is in alignment with the guide channels in the housing.

6. The device as claimed in claim 1, wherein the charging unit can be pushed laterally into a charging receiver of the housing and can be locked in the charging receiver

7. The device as claimed in any one of the preceding claims, claim 1, wherein the drive means, for the purpose of moving the piercing needles into the working position and/or into the rest position, in each case comprises mechanical, pneumatic and/or electrical drive means.

8. The device as claimed in claim 7, wherein the drive means, for the purpose of moving the piercing needles, comprises a servomotor or a linear motor.

9. The device as claimed in claim 1, wherein that the guide channels and the leadthroughs are in each case of the same diameter, of between 5 mm and 15 mm.

10. The device as claimed in any one of the preceding claims, claim 1, wherein, in the housing, at least three, preferably between four and sixteen guide channels in mutual alignment are provided in each case in the rear section and in the front section, and at least six, preferably between eight and sixteen leadthroughs are provided in the charging unit.

11. The device as claimed in any one of the preceding claims, claim 1, wherein the device is realized is a hand-held appliance.
